(19) United States
(12) Patent Application Publication
(10) Pub. No.: US 2014/0087937 A1
(43) Pub. Date: Mar. 27, 2014

(54) Catalytic Article for Decomposing Volatile Organic Compound and Method for Preparing the Same

(71) Applicant: National Yunlin University of Science & Technology, Yunlin (TW)

(72) Inventors: Bo-Tau Liu, Yunlin (TW); Cheng-Hsien Hsieh, Yunlin (TW); De-Hua Wang, Yunlin (TW)

(73) Assignee: National Yunlin University of Science & Technology, Yunlin (TW)

(21) Appl. No.: 14/036,121

(22) Filed: Sep. 25, 2013

Related U.S. Application Data
(63) Continuation-in-part of application No. 13/796,882, filed on Mar. 12, 2013.

(30) Foreign Application Priority Data
Sep. 21, 2012 (TW) 101134715

(51) Int. Cl. B01J 31/38

(52) U.S. Cl. CPC B01J 31/38
USPC 502/11; 502/300; 502/339; 502/344; 502/325; 502/319; 502/345; 502/347; 502/350; 502/240; 502/355; 502/349; 502/87; 502/304; 502/337; 502/338; 502/340; 502/167; 502/150; 502/217; 502/208; 502/216

(57) ABSTRACT

A catalytic article for decomposition of a volatile organic compound includes a porous support body, a plurality of active centers formed on the support body and adapted for catalytic decomposition of the volatile organic compound, and a plurality of capture centers bound to the support body. Each of the active centers is composed of one of a noble metal, a transition metal oxide, and the combination thereof. Each of the capture centers includes at least one functional group that is adapted for attracting or binding the volatile organic compound. A method for preparing the catalytic article is also disclosed.

### CROSS-REFERENCE TO RELATED APPLICATION

This application is a continuation-in-part (CIP) of co-pending U.S. patent application Ser. No.13/796882, filed on Mar. 12, 2013.

### CROSS-REFERENCE TO RELATED APPLICATION

This application claims priority of Taiwanese Application No.101134715, filed on Sep. 21, 2012.

### BACKGROUND OF THE INVENTION

1. Field of the Invention

This invention relates to a catalytic article, more particularly to a catalytic article for decomposing volatile organic compounds.

2. Description of the Related Art

Volatile organic compounds (abbreviated as VOCs hereinafter), such as formaldehyde (HCHO), exist in a variety of artificial products (like building or decorating materials and adhesives) and are released gradually into the air of an indoor living environment so as to cause damage to human body. Conventional methods to remove the VOCs are to utilize a variety of adsorbent materials to absorb/adsorb VOCs, or to utilize catalysts to decompose or oxidize VOCs directly into nontoxic substances.

Referring to FIG. 1, a conventional adsorbent material for VOCs 14 includes a support body 10 and a plurality of capture centers 12 bound on the support body 10 to adsorb the VOCs 14 via diffusion or forced convection. For example, Saeung et al. disclose an adsorbent material in Journal of Environmental Science 20 (2008), 379, and Afkhami et al. disclose another adsorbent material in Desalination 281 (2011), 151. Both of the adsorbent materials as set forth possess amino groups and are capable of adsorbing formaldehyde from the air or water. However, after a period of working time, the aforesaid adsorbent materials reach a saturated state and need to be processed using a regenerating system so as to recover the adsorbent ability for the VOCs.

Referring to FIG. 2, a conventional catalyst for decomposition of VOCs 24 is disclosed to include a support 20 and a plurality of active centers 21 formed on the support 21. Such active centers 21 contact the VOCs 24 via diffusion or forced convection and catalyze oxidation of the VOCs 24 so as to decompose the VOCs 24 in the air or water. For example, U.S. Pat. No. 5,882,616 and U.S. Pat. No. 6,458,741B, and Taiwanese Patent No. 1293036 disclose several metal or metal-oxide catalysts for decomposition of VOCs. However, while both VOC concentration and temperature are low, like an indoor living environment, these VOC catalysts lead to a relatively low decomposition rate and are not able to remove the VOCs efficiently.

### SUMMARY OF THE INVENTION

Therefore, the object of the present invention is to provide a catalytic article that is adapted for oxidative decomposition of VOCs, that is durable without aid from other regenerating systems, and that may alleviate the aforementioned drawbacks of the prior art.

According to one aspect of the present invention, a catalytic article includes:

a porous support body;

a plurality of active centers formed on the support body and adapted for oxidative decomposition of VOCs, each of the active centers being composed of one of a noble metal, a transition metal oxide, and the combination thereof; and

a plurality of capture centers bound to the support body, each of the capture centers including at least one functional group that is adapted for attracting or binding VOCs.

According to another aspect of the present invention, a method for preparing the aforesaid catalytic article includes the following steps:

(a) providing a porous support body;

(b) forming a plurality of active centers on the support body, the active centers being adapted for oxidative decomposition of VOCs, each of the active centers being composed of one of a noble metal, a transition metal oxide, and the combination thereof; and

(c) forming a plurality of capture centers on the support body through covalent bonding to obtain the catalytic article, each of the capture centers having at least one functional group that is capable of attracting or binding VOCs.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a schematic diagram illustrating a conventional adsorbent material structure for adsorbing VOCs;

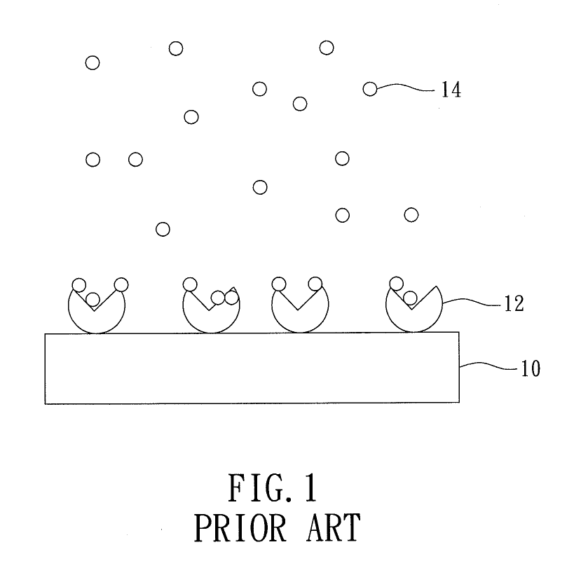

FIG. 2 is a schematic diagram illustrating a conventional catalyst structure for oxidative decomposition of VOCs;

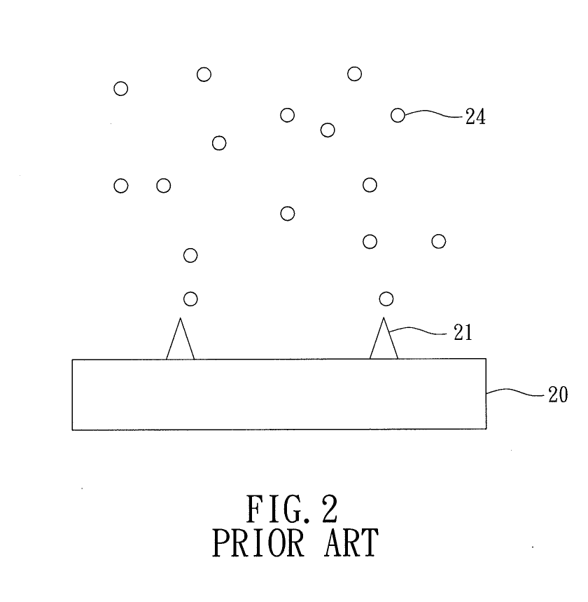

FIG. 3 is a schematic diagram illustrating a preferred embodiment of a catalytic article according to the present invention; and

FIG. 4 is a graph illustrating conversion of formaldehyde as a function of time for an example of the preferred embodiment of this invention (represented as (a)) and a comparative example (represented as (b)).

### DETAILED DESCRIPTION OF THE PREFERRED EMBODIMENTS

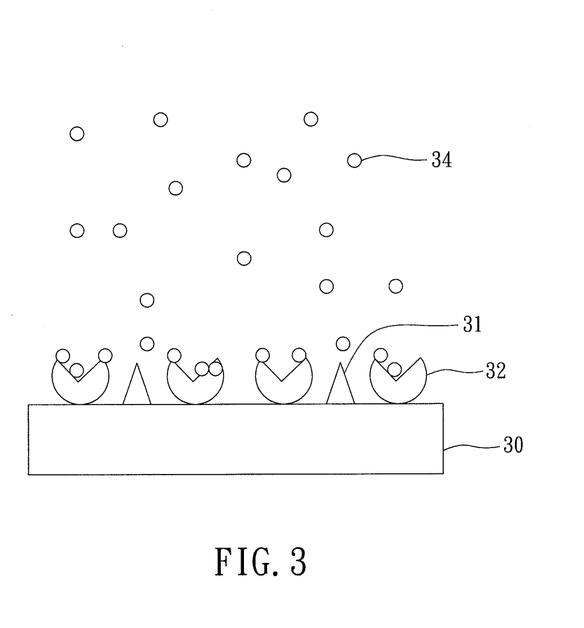

Referring to FIG. 3, a preferred embodiment of a catalytic article according to the present invention includes a porous support body 30, a plurality of active centers 31, and a plurality of capture centers 32. The active centers 31 are formed on the support body 30 for oxidative decomposition of VOCs and are composed of one of a noble metal, a transition metal oxide, and the combination thereof. The capture centers 32 are bound to the support body 30, and each of the capture centers 32 includes at least one functional group that is adapted for attracting or binding VOCs.

Preferably, the noble metal is selected from the group consisting of platinum, gold, rhodium, palladium and combinations thereof. In an example of this invention, the noble metal is platinum.

Preferably, the transition metal oxide is selected from the group consisting of chromium oxide, cobalt oxide, copper oxide, silver oxide, and combinations thereof.

Preferably, the support body 30 is made of a material selected from the group consisting of titanium dioxide, silicon dioxide, aluminum (III) oxide, zirconium dioxide, zeolite, cerium dioxide, nickel oxide, ferric oxide, ferriferous oxide, magnesium dioxide, and combinations thereof. In an example of this invention, the support body 30 is titanium dioxide.

Preferably, the capture centers 32 include one of an amino group, a hydroxyl group, a carboxyl group, a sulfate group, a sulfite group, and a phosphate group. In an example of this invention, the capture centers 32 include amino groups.

Preferably, the capture centers 32 are distributed on a surface of the support body 30 at a density of 10⁻⁶ mole/m² to 10⁻⁴ mole/m².

Preferably, the active centers 31 are present in an amount ranging from 0.01 wt % to 10 wt % based on the total weight of the catalytic article.

Accordingly, a method for preparing the catalytic article of the preferred embodiment includes the following steps:

(a) providing a porous support body 30;

(b) forming a plurality of active centers 31 on the support body 30, the active centers 31 being adapted for oxidative decomposition of VOCs, each of the active centers 31 being composed of one of a noble metal, a transition metal oxide, and the combination thereof; and

(c) forming a plurality of capture centers 32 on the support body 30 through covalent bonding to obtain the catalytic article, each of the capture centers 32 having at least one functional group that is capable of attracting or binding the VOCs.

Preferably, the active centers 31 are formed on the support body 30 by an impregnation method, a co-precipitation method, a deposition-precipitation method, an ion-exchange method, or a chemical vapor deposition method.

### EXAMPLES

### Example 1

3 grams of titanium dioxide (as a support body, P-25 commercially available from Degussa) was placed into a flask, followed by adding 67.9 μL of 8 wt % chloroplatinic acid (H₂PtCl₆) aqueous solution (a precursor of Pt,) into the flask and drying under 80° C. to obtain a pre-treated titanium dioxide. Then, the pre-treated titanium dioxide was mixed with 11 mg of sodium borohydride (NaBH₄) and 3.9 ml of water for inducing a reduction reaction, and a primary product was obtained after 4 to 5 hours of reaction. The primary product was washed with deionized water to remove unreacted sodium borohydride, followed by drying at 80° C., so as to obtain Ti0₂-supported Pt catalysts (denoted as Pt—TiO₂)

Thereafter, 3 grams of Pt—TiO₂, 0.3 gram of (3-aminopropyl)triethoxysilane (abbreviated as APTS, the capture centers of the catalytic article), 15.6 ml of alcohol, and 4.5 ml of 0.1 N nitric acid were mixed together and heated under 70° C. to react for 3 hours to obtain a crude product. The crude product was washed with ethanol to remove unreacted APTS, followed by drying at 80° C. to obtain the catalytic article of Example 1.

### Examples 2 to 6

The methods for preparing the catalytic articles of Examples 2 to 6 were similar to those of Example 1, except that various APTS amounts were used in Examples 2 to 6. The amounts of APTS for the catalytic articles of Examples 1 to 6 are listed in Table 1.

### Example 7

The catalytic article of Example 3 was mixed with P25 in the weight ratio of 1:1 to obtain the catalytic article of Example 7.

### Comparative Example 1

Pt—TiO₂ was used as the catalytic article in the following activity test.

### Comparative Example 2

The method for preparing the catalytic article of Comparative Example 2 was similar to that of Example 1. The difference between Comparative Example 2 and Example 1 resides in that APTS was reacted with TiO₂ instead of Pt—TiO₂ to obtain an APTS modified TiO₂ product, followed by mixing the APTS modified TiO₂ product with Pt—TiO₂ in the weight ratio of 1:1 to obtain a catalytic article of Comparative Example 2.

### <Activity Test>

The activity tests for the catalytic oxidation of HCHO were performed with a fixed-bed-reactor system at ambient temperature. 0.3 gram of the catalytic article of each of Examples and Comparative Examples was loaded in a fixed-bed reactor. A gas mixture including 10-ppm HCHO, which is generated from bubbling formalin solution through a carrier air flow, was conducted into the fixed-bed reactor under a gas hourly space velocity (GHSV) of 83000 h⁻¹. The outlet concentration of HCHO flowing from the fixed-bed reactor was analyzed using an electrochemical detector (TRACENOSE, model#: IAQ-F100). The HCHO conversion for the catalytic article of each of Examples 1 to 6 and Comparative Example 1 was determined using the following formula (I):

$$X ( \% ) = \frac{Cin - Cout}{Cin} \times 100 \% \qquad ( I )$$

wherein X (%), Cin, and Cout represent the HCHO conversion, the inlet HCHO concentration, and the outlet HCHO concentration, respectively. The experimental results are listed in Table 1.

TABLE 1

| Examples | APTS (g) | HCHO conversion (%) |
|---|---|---|
| Ex. 1 | 0.3 | 16.4 |
| Ex. 2 | 1.5 | 20.0 |
| Ex. 3 | 3.0 | 25.6 |
| Ex. 4 | 3.3 | 20.9 |
| Ex. 5 | 3.6 | 15.5 |
| Ex. 6 | 6.0 | 13.6 |
| C. E. 1 | 0 | 10.7 |

As shown in Table 1, the HCHO conversion of the catalytic article of Comparative Example 1, where APTS was not used, is only 10.7%. However, with the increase of APTS-used amount, the HCHO conversion increases rapidly, reaches a maximum, and decreases thereafter. The catalytic article of Example 3 shows the best activity, wherein the surface density of the amino groups of APTS distributed on the surface of TiO₂ was measured as 4.5×10⁻⁵ mol/m² via a titration method. The increase of the HCHO conversion may be ascribed to the synergistic effect of Pt (i.e., the active centers) and amino groups of APTS (i.e., the capture centers), wherein APTS increases the local concentration of HCHO for Pt active centers to increase the HCHO decomposition rate. However, when the ratio of the weight of APTS over the weight of Pt—TiO₂ increases from 1.1:1 to 2:1 (Examples 4 to 6), the excessive amount of APTS covers some of Pt particles on the surface of T10₂, thereby resulting in the decease of the HCHO conversion (from 20.9% to 13.6%).

### [Analysis of Effect of Locations of the APTS Capture Centers and the Pt Active Centers on HCHO Conversion]

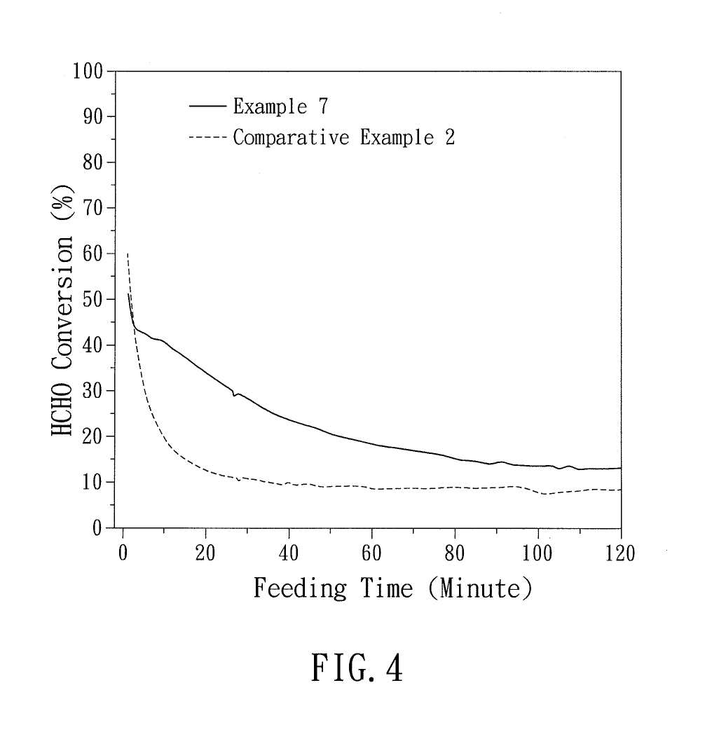

The HCHO conversion of the catalytic article of each of Example 7 and Comparative Example 2 with respect to feeding time is plotted in FIG. 4. After 120 minutes, the system approaches stable, as shown in FIG. 4, and the HCHO conversions for Example 7 (FIG. 4(a)) and for Comparative Example 2 (FIG. 4(b)) are 13.1% and 8.8%, respectively, indicating that the catalytic article featuring the capture centers (amino groups) and the active centers (Pt) located on the same supports (TiO₂) (Example 7) has higher activity than those featuring the capture centers and the active centers located on the different supports (Comparative Example 2). This implies that the synergistic effect will reduce if the distance between the amino group of APTS and Pt increases.

To sum up, the capture centers 32 of the catalytic article of the present invention increase the local concentration of the VOCs 34 around the active centers 31 of the catalytic article, thereby improving decomposition of the VOCs 34 under room temperature and low VOC concentration. Moreover, since the VOCs 34 captured by the capture centers 32 are decomposed by the active centers 31, the capture centers 32 could be regenerated, thereby maintaining high adsorbing efficiency of the capture centers 32 for a long period of working time.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A catalytic article for decomposition of a volatile organic compound, said catalytic article comprising:
a porous support body;
a plurality of active centers formed on said support body and adapted for catalytic decomposition of the volatile organic compound, each of said active centers being composed of one of a noble metal, a transition metal oxide, and the combination thereof; and
a plurality of capture centers bound to said support body, each of said capture centers including at least one functional group that is adapted for attracting or binding the volatile organic compound.

2. The catalytic article as claimed in claim 1, wherein said noble metal is selected from the group consisting of platinum, gold, rhodium, palladium and combinations thereof.

3. The catalytic article as claimed in claim 1, wherein said transition metal oxide is selected from the group consisting of chromium oxide, cobalt oxide, copper oxide, silver oxide and combinations thereof.

4. The catalytic article as claimed in claim 1, wherein said support body is made of a material selected from the group consisting of titanium dioxide, silicon dioxide, aluminum(III) oxide, zirconium dioxide, zeolite, cerium dioxide, nickel dioxide, ferric oxide, ferriferous oxide, magnesium dioxide, and combinations thereof.

5. The catalytic article as claimed in claim 1, wherein said functional group of each of said capture centers is selected from the group consisting of an amino group, a hydroxyl group, a carboxyl group, a sulfate group, a sulfite group, and a phosphate group.

6. The catalytic article as claimed in claim 1, wherein said capture centers are distributed on a surface of said support body at a density of 10⁻⁶ mole/m² to 10⁻⁴ mole/m².

7. The catalytic article as claimed in claim 1, wherein said active centers are present in an amount ranging from 0.01 wt % to 10 wt % based on the total weight of said catalytic article.

8. A method for preparing a catalytic article, comprising the following steps:
(a) providing a porous support body;
(b) forming a plurality of active centers on the support body, the active centers being adapted for catalytic decomposition of a volatile organic compound, each of the active centers being composed of one of a noble metal, a transition metal oxide, and the combination thereof; and
(c) forming a plurality of capture centers on the support body through covalent bonding to obtain the catalytic article, each of the capture centers having at least one functional group that is capable of attracting or binding the volatile organic compound.

9. The method as claimed in claim 8, wherein, instep (b), the active centers are formed on the support body by an impregnation method, a co-precipitation method, a deposition-precipitation method, an ion-exchange method, or a chemical vapor deposition method.

10. The method as claimed in claim 8, wherein, in step (b), the active centers are present in an amount ranging from 0.01 wt % to 10 wt % based on the total weight of the catalytic article.

11. The method as claimed in claim 8, wherein, in step (c), the capture centers are distributed on a surface of the support body at a density of 10⁻⁶ mole/m² to 10⁻⁴ mole/m².
